(19) United States
(12) Patent Application Publication
(10) Pub. No.: US 2010/0185872 A1
(43) Pub. Date: Jul. 22, 2010

(54) SYSTEM, METHOD AND APPARATUS FOR READING CONTENT OF EXTERNAL STORAGE DEVICE

(75) Inventors: Teng Pin Poo, Singapore (SG); Henry Tan, Singapore (SG)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Trek 2000 International Ltd., Singapore (SG)

(21) Appl. No.: 12/095,118

(22) PCT Filed: Jun. 19, 2007
(86) PCT No.: PCT/SG07/00167

§ 371 Date: May 27, 2008

(51) Int. Cl. G06F 12/14; G06F 12/00

(52) U.S. Cl. 713/189; 711/163; 711/E12.092; 711/E12.001

(57) ABSTRACT

A system for enabling the reading on a reader of content stored in an external storage device is disclosed. The reader is a read-only device and has a display, a processor for controlling the operation of the reader, and a port for operative connection of the external storage device. The external storage device has a non-volatile storage and a central processor. The central processor is able to download to the reader the content stored in the non-volatile storage upon a pre-condition being established. The pre-condition is at least one of receipt of a correct encryption key from the reader, and arrival at a start date and time as determined by a real-time clock. The reader, external storage device, and a corresponding method are also disclosed.

### TECHNICAL FIELD

This invention relates to a system, method and apparatus for reading the content of an external storage device, and for an external storage device to enable such a reading.

### BACKGROUND

External storage devices for use with computers and like apparatus have become common. For example, USB Flash drives are now quite small and have a storage capacity of up to several GB. Portable disc drives are now quite compact and have a storage capacity that is even greater. However, to read content stored on such an external storage device normally requires a machine such as a full-function PC, laptop, PDA or the like. Such machines are of necessity relatively complex and expensive as they are readers, generators, receivers and transmitters of content. A relatively simple and inexpensive machine is desirable. Also, controls over access to stored content such as by encryption and/or time may be of advantage.

### SUMMARY

According to an exemplary aspect there is provided a system for enabling the reading on a reader of content stored in an external storage device; the reader being a read-only device and having a display, a processor for controlling the operation of the reader, a port for operative connection of the external storage device; the external storage device having a non-volatile storage and a central processor, the central processor being able to download to the reader the content stored in the non-volatile storage upon a pre-condition being established; the pre-condition being at least one selected from the group consisting of: receipt of a correct encryption key from the reader, and arrival at a start date and time as determined by a real-time clock.

The real-time clock may be a part of the external storage device. The reader may have a plurality of controls for controlling the display. The plurality of controls may include at least one of: colour, brightness, contrast, on/off, zoom, and cursor. The encryption key may be stored in the reader, and may be sent to the external storage device following operative connection of the external storage device and the reader. The central processor may store the start date and time. The central processor may also store an end date and time. The real-time clock may also determine arrival at the end date and time. Upon arrival at the end date and time, all downloading may cease and the content may no longer displayed on the reader. The reader may further comprise a buffer for smooth downloads and display. The external storage device may further comprise an encryption module for encrypting and decrypting the content using the encryption key.

According to another exemplary aspect there is provided a reader, the reader being a read-only device and having a display, a processor for controlling the operation of the reader, a port for operative connection of the external storage device; the reader being able to download to the reader content stored in a non-volatile storage upon a pre-condition being established; the pre-condition being at least one selected from the group consisting of: sending of a correct encryption key by the reader to the external storage device, and arrival at a start date and time as determined by a real-time clock.

The real-time clock may be a part of the external storage device or a part of the reader. The reader may have a plurality of controls for controlling the display. The plurality of controls may include at least one of: colour, brightness, contrast, on/off, zoom, and cursor. The encryption key may be stored in the reader, and may be sent to the external storage device following operative connection of the external storage device and the reader. The reader may further comprise a buffer for smooth downloads and display. The reader may be for use in the system described above.

According to a further exemplary aspect there is provided an external storage device comprising a non-volatile storage and a central processor, the central processor being able to download to a reader content stored in the non-volatile storage upon a pre-condition being established; the pre-condition being at least one selected from the group consisting of: receipt of a correct encryption key from the reader, and arrival at a start date and time as determined by a real-time clock.

The real-time clock may be a part of the external storage device. The encryption key may be stored in the reader and may be sent to the external storage device following operative connection of the external storage device and the reader. The central processor may store the start date and time. The central processor may also store an end date and time. The real-time clock may also determine arrival at the end date and time. Upon arrival at the end date and time, all downloading may cease and the content may no longer displayed on the reader. The external storage device may further comprise an encryption module for encrypting and decrypting the content using the encryption key.

According to a final exemplary aspect there is provided a method for enabling the reading on a reader of content stored in an external storage device; the reader being a read-only device and having a display, a processor for controlling the operation of the reader, a port for operative connection of the external storage device; the external storage device having a non-volatile storage and a central processor; the method comprising connecting the external storage device to the reader using the port, and establishing a pre-condition, the central processor being able to download to the reader the content stored in the non-volatile storage upon the pre-condition being established; the pre-condition being at least one selected from the group consisting of: receipt of a correct encryption key from the reader, and arrival at a start date and time as determined by a real-time clock.

The real-time clock may be a part of the external storage device. The encryption key may be stored in the reader and may be sent to the external storage device following operative connection of the external storage device and the reader. The central processor may store the start date and time. The central processor may also store an end date and time. The real-time clock may also determine arrival at the end date and time. Upon arrival at the end date and time, all downloading may ceases and the content may no longer be displayed on the reader.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is a front perspective view of an assembly of an exemplary reader and external storage device;

FIG. 2 is a block diagram of the exemplary reader of FIG. 1;

FIG. 3 is a block diagram of the exemplary external storage device of FIG. 1;

FIG. 4 is a flow chart for an exemplary operation of the assembly of FIG. 1;

FIG. 5 is a flow chart for an alternative exemplary operation of the assembly of FIG. 1; and

FIG. 6 is a flow chart for a further exemplary operation of the assembly of FIG. 1.

### DETAILED DESCRIPTION OF EXEMPLARY EMBODIMENTS

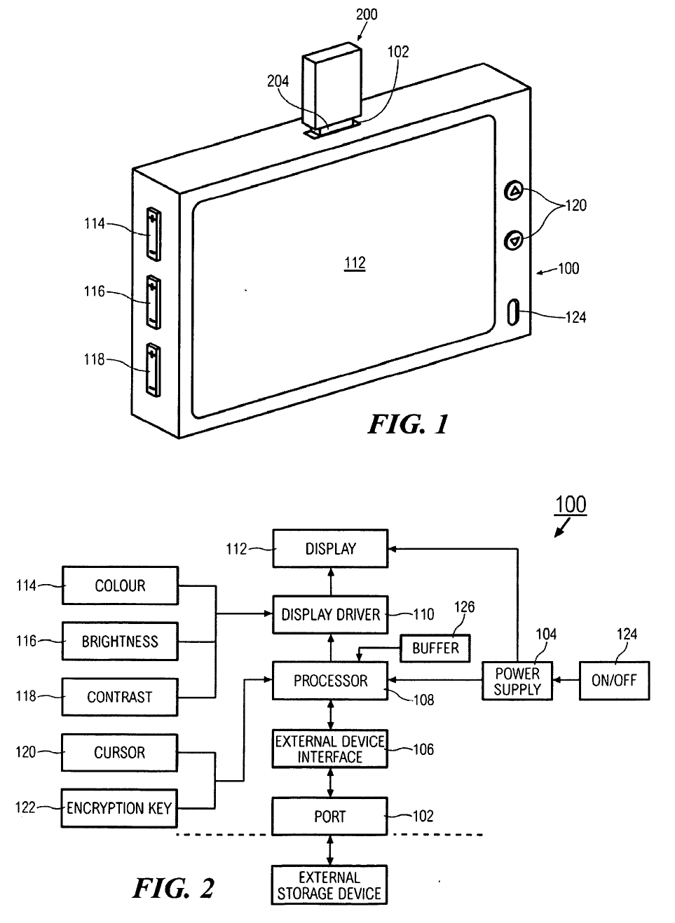

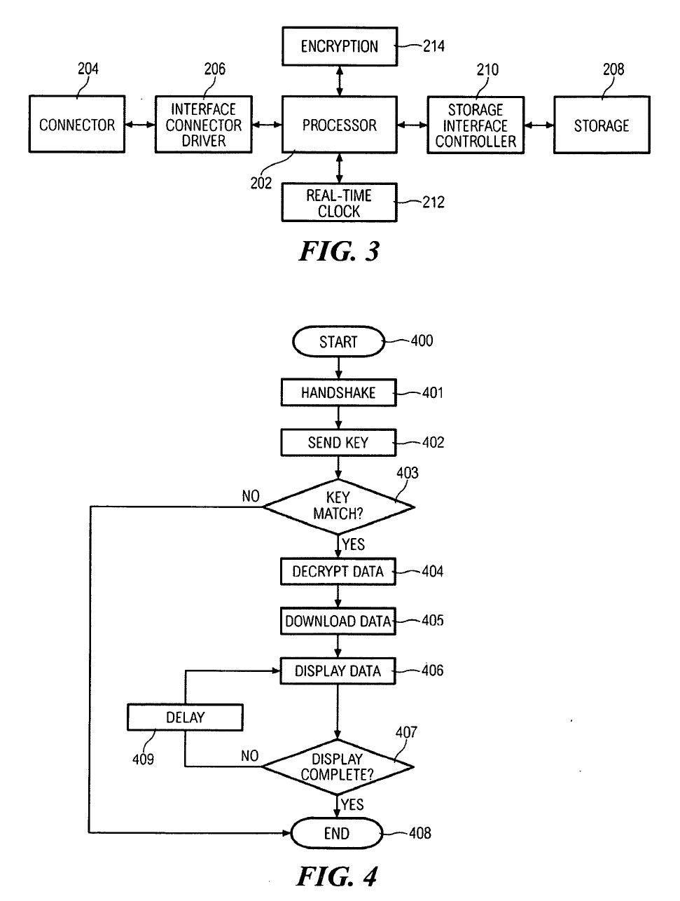

To refer to FIGS. 1 to 3, there is shown a reader 100 and an external storage device 200. The external storage device 200 as shown is a SUB Flash drive. However, it is not so limited and may be any form of external storage device including, but not limited to, disc drive, flash card, compact flash card, secure digital card, xD picture card, Memory Stick, smart media card, multimedia card or the like. The reader 100 has a port 102 for releasably and operatively receiving the external storage device 200. preferably, the external storage device 200 is connected directly to the port 102, although an intervening cable may be used if required or desired.

The reader 100 has a power supply 104 that may be one or more batteries and/or mains supply for supplying power to a processor 108 and a display 112. The processor 108 controls the operations of the reader 100. The port 102 has an interface 10 that is operatively connected to the processor 108. The display 112 has a display driver 110 operatively connected to the processor 108 and the display 112. External controls for colour 114, brightness 116 and/or contrast 118 may be provided, if required or desired. The external controls 114, 116, 118 may be simple “+ −” controls as often used on monitors and the like.

In addition, “cursor” controls 120 are provided for controlling reading direction on display 112—up or down. A zoom control (not shown) may also be provided. A final control may be an on/off switch 124.

Furthermore, an encryption key 122 may be stored in reader 100, as will be understood from the description below. The encryption key 122 is pre-loaded into the reader 100. It may be amended, replaced, updated or corrected from time-to-time by a control authority (not shown) using communication through port 102 to access the processor 108 and encryption key 122. The encryption key 122 for a reader 100 is preferably unique for that reader 100, although readers 100 for a common use may have a common encryption key 122.

The reader 100 does not have a key pad on keyboard, nor a touch sensitive screen. Its sole purpose is to display the data stored on external storage device 200. It cannot amend, delete, or add to that data. The reader 100 is a read-only device.

The external storage device 200 is preferably able to connect directly with the reader 100 via port 102. The external storage device 200 has a processor 202 that is operatively connected to a connector 204 via a connector drives 206. It is also operatively connected to a non-volatile storage or memory 208 via a storage controller 210.

The external storage device 200 also has a real-time clock 212, and an encryption module 214. The encryption module 214 is for encrypting and decrypting data stored in storage 208. The real-time clock 212 is for controlling a time and date of release of data stored in storage 208. The encryption module 214 and real-time clock 212 may be used together, independently, or not at all. This will depend on the requirements in relation to the data stored in storage 208.

There are three possible methods of operation:
(i) no encryption and no time constraints;
(ii) encryption but no time constraints;
(iii) no encryption but with time constraints; and
(iv) both encryption and time constraints.

The first possible method is therefore relatively standard and will not be described in detail.

The second is illustrated in FIG. 4. At the start 400 the external storage device 200 is operatively connected to reader 100 by inserting connector 204 into port 102. The processors 108, 202 then perform the usual handshake procedure (401). Upon completion of the handshake procedure, the reader 100 sends its pre-loaded encryption key 122 to the processor 202 and thus encryption module 214 (402). A determination is then made whether the key 122 is a match (403). If no, the process ends (408). If yes, the required data in storage 208 is decrypted using the key 122 (404) and downloaded to reader 100 (405). The data is then displayed at reader 100 on display screen 112 (406). Due to the potential size of the stored data, a buffer 126 may be included in reader 100 for smooth and continuous downloads and display.

A determination is then made if the display is complete (407). This may be on a basis of time, all of the data having been read, user action in switching off reader 100, and so forth. If yes, the process ends (408). If no, after a short time delay (e.g. a few minutes) (409) the process reverts to (407).

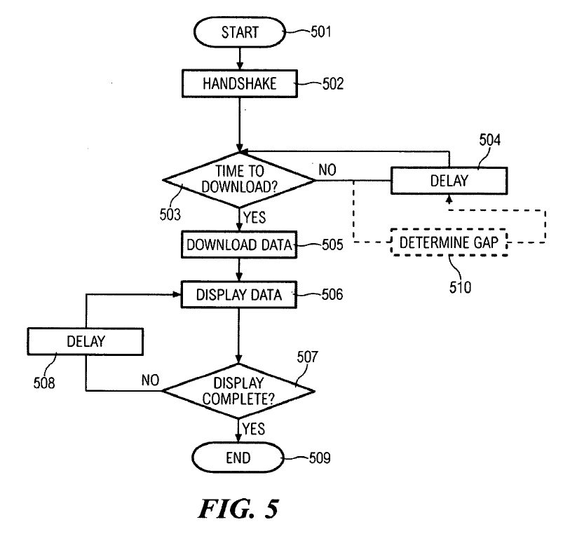

The third is illustrated in FIG. 5. At the start 501 the external storage device 200 is operatively connected to reader 100 by inserting connector 204 into port 102. The processors 108, 202 then perform the usual handshake procedure (502). Upon completion of the handshake procedure, a determination is then made whether it is the correct date and time for downloading to proceed (503) using real-time clock 212. The correct date and time for downloading is pre-stored in processor 202 by an administrator (not shown). If no, after a short delay (504) the determination is repeated (505). Additionally or alternatively, the time gap from the present date and time to the pre-stored date and time is determined (510) and the process of (503) is repeated at the expiry of that time gap. If yes, the required data in storage 208 is downloaded to reader 100 (505). The data is then displayed at reader 100 on display screen 112 (506). Due to the potential size of the stored data, a buffer 126 may be again included in reader 100 for smooth and continuous downloads and display.

A determination is then made if the display is complete (507). This may be on a basis of time, all of the data having been read, user action is switching off reader 100, and so forth. By time it is meant that an expiry date and time may also be stored in processor 202 so that at the when the expiry time and date are arrived at, the downloading will cease and all data at the reader 100 will be removed such that all display of data at reader 100 ceases. If yes, the process ends (509). If no, after a short time delay (e.g. a few minutes, (508) the process reverts to (506).

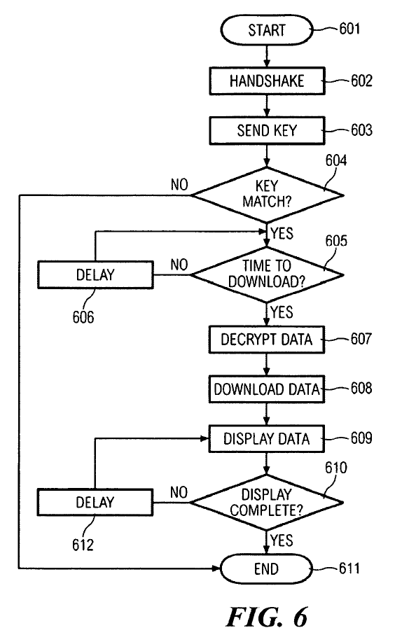

The fourth option is illustrated in FIG. 6. At the start 601 the external storage device 200 is operatively connected to reader 100 by inserting connector 204 into port 102. The processors 108, 202 then perform the usual handshake procedure (602). Upon completion of the handshake procedure, the reader 100 sends its pre-loaded encryption key 122 to the process 202 and thus encryption module 214 (603). A determination is then made whether the key 122 is a match (604). If no, the process ends (611). If yes, a determination is made using real-time clock 212 whether the time to download (605) has arrived, or is just passed. Just passed is to allow a short time interval after the due date and time in case of delayed insertion of external storage device 200 into port 102. If no, after a short delay (606) the process reverts to (605). If yes, the data is decrypted using key 122 (607), downloaded to reader 100 (608), and displayed on display screen 112 (609). Due to the potential size of the stored data, a buffer 126 may be again included in reader 100 for smooth and continuous downloads and display.

A determination is then made if the display is complete (610). This may be on a basis of time, all of the data having been read, user action is switching off reader 100, and so forth. By time it is meant that an expiry date and time may also be stored in processor 202 so that at the when the expiry time and date are arrived at, the downloading will cease and all data at the reader 100 will be removed and encrypted such that all display of data at reader 100 ceases. If yes, the process ends (611). If no, after a short time delay (e.g. a few minutes, (612) the process reverts to (609).

The downloading by time may be for different files at different times. Similarly, the downloading may be for different files for different encryption keys.

The reader 100 and the external storage device 200 may therefore be used to advantage in those situations where it is desired to have one or more persons read content of the external storage device 200 but only at a predetermined date and time. This may be relevant in situations such as, for example, examinations where the content is the examination paper; media briefings where the content is the full media release; government agencies or departments for the release of important papers such as, for example, budget papers; and so forth. By having an expiry time, the examination use is enhanced as the expiry time would be the end time of the examination. In this way candidates must stop work at the allocated time as the examination paper is no longer readable by the candidate. Even if the external storage device 200 is inserted into the port 102 and reader 100 switched on before the pre-stored start date and time, downloading will not commence until that pre-stored start date and time; and at the expiry sate and time all reading would cease.

The real-time clock 212 may form part of the reader 100 rather than the external storage device 200.

Whilst there has been described in the foregoing description exemplary embodiments, it will be understood by those skilled in the technology concerned that many variations in details of design, construction and/or operation may be made without departing from the present invention.

1. A system for enabling the reading on a reader of content stored in an external storage device; the reader being a read-only device and having a display, a processor for controlling the operation of the reader, a port for operative connection of the external storage device; the external storage device having a non-volatile storage and a central processor, the central processor being able to download to the reader the content stored in the non-volatile storage upon a pre-condition being established; the pre-condition being at least one selected from the group consisting of: receipt of a correct encryption key from the reader, and arrival at a start date and time as determined by a real-time clock.

2. A system as claimed in claim 1, wherein the real-time clock is selected from the group consisting of: a part of the external storage device, and a part of the reader.

3. A system as claimed in claim 1, wherein the reader has a plurality of controls for controlling the display, the plurality of controls including at least one selected from the group consisting of: colour, brightness, contrast, on/off, zoom, and cursor; the reader storing the encryption key and being sent to the external storage device following operative connection of the external storage device and the reader.

4. (canceled)

5. A system as claimed in claim 1, wherein the central processor stores the start date and time; the central processor also storing an end date and time, the real-time clock also for determining arrival at the end date and time; and upon arrival at the end date and time, all downloading ceases and the content is no longer displayed on the reader.

6-7. (canceled)

8. A system as claimed in claim 1, wherein the reader further comprises a buffer for smooth downloads and display; and the external storage device further comprises an encryption module for encrypting and decrypting the content using the encryption key.

9. (canceled)

10. A reader the reader being a read-only device and having a display, a processor for controlling the operation of the reader, a port for operative connection of the external storage device; the reader being able to download to the reader content stored in a non-volatile storage upon a pre-condition being established; the pre-condition being at least one selected from the group consisting of: sending of a correct encryption key by the reader to the external storage device, and arrival at a start date and time as determined by a real-time clock.

11. A reader as claimed in claim 10, wherein the real-time clock is selected from the group consisting of: a part of the external storage device; and a part of the reader.

12. (canceled)

13. A reader as claimed in claim 10, wherein the reader has a plurality of controls for controlling the display, the plurality of controls including at least one selected from the group consisting of: colour, brightness, contrast, on/off, zoom, and cursor, and the reader stores the encryption key and is sent to the external storage device following operative connection of the external storage device and the reader.

14. (canceled)

15. A reader as claimed in claim 10, wherein the reader further comprises a buffer for smooth downloads and display.

16. A reader as claimed in claim 10, wherein the reader is for use in the system of claim 1.

17. An external storage device comprising a non-volatile storage and a central processor, the central processor being able to download to a reader content stored in the non-volatile storage upon a pre-condition being established; the pre-condition being at least one selected from the group consisting of: receipt of a correct encryption key from the reader, and arrival at a start date and time as determined by a real-time clock.

18. An external storage device as claimed in claim 17, wherein the real-time clock is a part of the external storage device; and the encryption key is stored in the reader and is sent to the external storage device following operative connection of the external storage device and the reader.

19. (canceled)

20. An external storage device as claimed in claim 17, wherein the central processor stores the start date and time; as well as an end date and time, the real-time clock also determining arrival at the end date and time such that upon arrival at the end date and time, all downloading ceases and the content is no longer displayed on the reader.

21-22. (canceled)

23. An external storage device as claimed claim 17, wherein the external storage device further comprises an encryption module for encrypting and decrypting the content using the encryption key.

24. A method for enabling the reading on a reader of content stored in an external storage device; the reader being a read-only device and having a display, a processor for controlling the operation of the reader, a port for operative connection of the external storage device; the external storage device having a non-volatile storage and a central processor; the method comprising connecting the external storage device to the reader using the port, and establishing a pre-condition, the central processor being able to download to the reader the content stored in the non-volatile storage upon the pre-condition being established; the pre-condition being at least one selected from the group consisting of: receipt of a correct encryption key from the reader, and arrival at a start date and time as determined by a real-time clock.

25. A method as claimed in claim 24, wherein the real-time clock is a part of the external storage device and the encryption key is stored in the reader and is sent to the external storage device following operative connection of the external storage device and the reader.

26. (canceled)

27. A method as claimed in claim 24, wherein the central processor stores the start date and time as well as an end date and time, the real-time clock also determines arrival at the end date and time such that upon arrival at the end date and time, all downloading ceases and the content is no longer displayed on the reader.

28-29. (canceled)
